(19) United States
(12) Patent Application Publication
(10) Pub. No.: US 2023/0169578 A1
(43) Pub. Date: Jun. 1, 2023

(54) METHOD AND SYSTEM FOR UNDERTAKING A TRANSACTION IN A THREE-DIMENSIONAL (3D) INTERACTIVE ENVIRONMENT

(71) Applicant: Flipkart Internet Private Limited, Bengaluru (IN)

(72) Inventors: Varahur Kannan Sai KRISHNA, Bengaluru (IN); Ajay Ponna VENKATESHA, Bengaluru (IN)

(73) Assignee: Flipkart Internet Private Limited, Bengaluru (IN)

(21) Appl. No.: 17/671,132

(22) Filed: Feb. 14, 2022

(30) Foreign Application Priority Data
Dec. 1, 2021 (IN) 202141055732

(51) Int. Cl. G06Q 30/06; G06Q 20/36; G06T 19/00

(52) U.S. Cl. CPC G06Q 30/0643; G06Q 20/3678; G06Q 30/0625; G06Q 30/0613; G06Q 30/0635; G06T 19/003; G06Q 2220/00

(57) ABSTRACT

A method and system for undertaking a transaction in a Three-Dimensional (3D) interactive environment. The method includes invoking, by a processor associated with a system, from a source application, using a widget, a metaverse environment from a plurality of available metaverse environments, the invocation of the metaverse environment enabling a user to undertake experiential experiments on a plurality of products that form part of the invoked metaverse environment. The method includes selecting one or more products based on the experiential experiments. Further, the method includes processing, by the processor, in the invoked metaverse environment, using a meta-cart checkout engine of the invoked metaverse environment, purchase transaction for the selected one or more products, wherein the meta-cart checkout engine places the selected one or more products into a cart along with transmitting 3D metadata associated with the one or more products to a server.

### FIELD OF INVENTION

The embodiments of the present disclosure generally relate to a method and a system for delivering and managing contents in multiple metaverse environments. More particularly, the present disclosure relates to a method and a system for undertaking a transaction in a Three-Dimensional (3D) interactive environment.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Generally, consumers of digital entertainment provided in interactive or non-interactive media may engage with media to a large extent, particularly with interactive media. An example of interactive media may be video games. Consumers invest time and/or resources progressing through events in the interactive media. One example of the events may be a development of a digital character or avatar (collectively referred to as a character) that may be represented in a virtual universe provided by the interactive media. Such development can include customizing the appearance or likeness of the character, improving the characteristics of the character, including personal characteristics or accessories, or engaging in various events with the character. The consumer preferably can control the character in an interactive environment. This allows the character to be part of an interactive adventure, while characteristics of the character are improved as the adventure progresses. Examples of such virtual universes include both offline and online universes. However, the applications may be beyond gaming, role-playing, business collaboration, and/or social interaction. A core megatrend of forthcoming future society lies in establishing social networks in which users directly participate, thereby allowing users to engage in an all-encompassing field of activities including educational, economic, and cultural activities, and enabling creative users to freely create, sell, develop and share characters and spaces in a mixed reality environment. Recently, people are building lasting virtual relationships, owning and decorating virtual spaces, and competing for scarce virtual resources across a multitude of distinct virtual ecosystems. As augmented reality becomes more pervasive, virtual overlays may be playing part in how users view the physical world that, it can still be like the real world. As Virtual Reality (VR) hardware becomes more advanced and more affordable, these virtual experiences may become more real and the line between the physical world and the virtual worlds may begin to be same. Aside from hardware, the biggest obstacle to the growth of virtual reality is the absence of a coherent cross-world ecosystem. While some virtual worlds strive toward universality, most common virtual environments are intentionally limited to certain games, objectives, or communities. Eventually, a shared interface may develop to connect virtual spaces with the Augmented Reality (AR) enhanced physical world. The Extended Reality (XR) may be impacting the world in almost every sphere of human life. One of its major bearings is the ability to provide immersive web experiences from a mere Two-Dimensional (2D) web which the world is used to until date. The ability to traverse in spatial-web may led to the emergence of a new technology domain in its entirety. That collective, persistent layer of connected virtual worlds may be known as “a metaverse”.

Currently, there may be no persistent method(s) to invoke metaverse environment from one or more web pages of an e-commerce websites/portals. A checkout process in the e-commerce portals may not enable Three-Dimensional (3D) based virtual product trials possible through a combination of online and offline toggle of active check-out carts between both the web and the metaverse environments. As virtual environments become imbued with the characteristics of the physical world, (e.g., utilizing avatars having the same face/body model of the people they represent), a user or group of users may desire to interact in the virtual environment in same way as in the normal world. These workflows would include the ability to transact, purchase or try-on e-commerce products. For example, a group of users wishing to purchase products may desire to have the virtual try-on process on the respective avatar of users before making a digital and/or physical purchase.

Therefore, there is a need to provide method and system for solving the shortcomings of the current technologies, by providing a method and a system for undertaking a transaction in a Three-Dimensional (3D) interactive environment. Further, there is a need for providing a method and a system for reviewing products that can be saved, stored, fitted and purchased through a 3-D interactive environment, with a direct impact on the real-world counterparts. A further need exists for a method and a system for reviewing the events that occurred in a 3-D interactive environment which includes the ability to review products introduced by an outside source, such as a 2D e-commerce destination or storefront. Another need exists for a method and a system for reviewing products that occurred in a 3-D interactive environment which may be viewed from a plurality of viewpoints for the user to better understand the details of the product.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may for undertake a transaction in a Three-Dimensional (3D) interactive environment.

It is an object of the present disclosure to provide a method and system for undertaking a transaction in a Three-Dimensional (3D) interactive environment. The present disclosure provides a method and system for invoking, utilizing and minting one or more products using a metaverse cart checkout process in a metaverse environment. The metaverse environment may be invoked from existing web pages, websites, browsers, applications, platforms, using widgets, plugins that are browser and platform agnostic.

It is another object of the present disclosure to present disclosure significantly improves the buying process of the one more product on e-commerce by leveraging tools of an internet and a metaverse environment to engage, inform and build enough conviction on choices buyers are making as products/brands.

It is another object of the present disclosure to provide a method and system for check-out of purchases within a browser or a metaverse environment that can be conveniently and seamlessly experienced at different points in time by the buyer. The flexibility to load one or more products into a meta-cart enables the buyer to increase confidence on the product opted for buying, upon associating the product simulations and validation in the metaverse environment.

It is yet another object of the present disclosure to provide a method and system for providing the buyer with a Non-Fungible Token (NFT) instance of the purchase transaction so that transaction and the transaction ownership is block-chain imprinted assuring of the needed hygiene to further transact within the metaverse environment. The present disclosure provides a method and system for optimizing the NFT generation costs by providing mint NFT technique in the overall meta-cart check-out process keeping a digital wallet value optimization in focus. The present disclosure provides a method and system for conjoint process of purchase/toggle between both the web and the metaverse environments in ecommerce.

It is another object of the present disclosure to provide comfort and conviction of a fully validated purchase transaction. The present disclosure provides ownership to the user, as basis for any digital instance of a product and enabling blockchain validation of such ownerships through Non-Fungible Tokens (NFTs) to avoid confusion and fraudulent resale of a pre-owned product.

It is another object of the present disclosure to provide meta-cart checkout purchase/buying process flow that integrates the web and Metaverse environments from the standpoint of immersive commerce that gives the user both the convenience and conviction to buy after getting a comprehensive and real sense of the products in terms of its size, scale, fit, detail & configuration/customization options. the meta-cart checkout process is aimed at stacking the shopping cart provisionally (or it can also be treated as the penultimate shopping cart, not the final check-out ready cart) with items that are both meta-verse experience-able and otherwise.

In an aspect, the present disclosure includes a method for undertaking a transaction in a Three-Dimensional (3D) interactive environment. The method includes invoking from a source application, using a widget, a metaverse environment from a plurality of available metaverse environments, the invocation of the metaverse environment enabling a user to undertake experiential experiments on a plurality of products that form part of the invoked metaverse environment. The method includes selecting one or more products based on the experiential experiments. Further, the method includes processing in the invoked metaverse environment, using a meta-cart checkout engine of the invoked metaverse environment, purchase transaction for the selected one or more products. The meta-cart checkout engine places the selected one or more products into a cart along with transmitting 3D metadata associated with the one or more products to a server.

In another aspect, the present disclosure includes a system for undertaking a transaction in a Three-Dimensional (3D) interactive environment. The system includes a processor, a memory storing a set of instructions. When set of instructions is executed by the processor, the processor invokes, from a source application, using a widget, a metaverse environment from a plurality of available metaverse environments, the invocation of the metaverse environment enabling a user to undertake experiential experiments on a plurality of products that form part of the invoked metaverse environment. The system via the processor selects one or more products based on the experiential experiments. Further, the system via the processor processes, in the invoked metaverse environment, using a meta-cart checkout engine of the invoked metaverse environment, purchase transaction for the selected one or more products. The meta-cart checkout engine places the selected one or more products into a cart along with transmitting 3D metadata associated with the one or more products to a server.

### BRIEF DESCRIPTION OF THE ACCOMPANYING DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/sub components of each component. It will be appreciated by those skilled in the art that invention of such drawings includes the invention of electrical components, electronic components or circuitry commonly used to implement such components.

FIG. 1 illustrates an exemplary block diagram representation of a network architecture implementing a proposed system for undertaking a transaction in a Three-Dimensional (3D) interactive environment, according to embodiments of the present disclosure.

FIG. 2A illustrates an exemplary detailed block diagram representation of the proposed system, according to embodiments of the present disclosure.

FIG. 2B illustrates an exemplary detailed block diagram representation of the proposed system comprising a meta-verse application, according to embodiments of the present disclosure.

FIG. 3A illustrate exemplary graphical representations of metaverse widget, according to embodiments of the present disclosure.

FIG. 3B illustrates an exemplary block diagram representation of components of the metaverse widget, according to embodiments of the present disclosure.

FIG. 3C illustrates an exemplary block diagram representation of metaverse cart, according to embodiments of the present disclosure.

FIG. 3D illustrates a flow diagram depicting a method of meta physical minting of Non-Fungible Tokens (NFTs), according to embodiments of the present disclosure.

FIG. 4 illustrates a flow chart depicting method of undertaking a transaction in a Three-Dimensional (3D) interactive environment, according to embodiments of the present disclosure.

FIG. 5 illustrates a hardware platform for implementation of the disclosed system according to embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure provides a method and system for undertaking a transaction in a Three-Dimensional (3D) interactive environment. The present disclosure provides a method and system for invoking, utilizing and minting one or more products using a metaverse cart checkout process in a metaverse environment. The metaverse environment may be invoked from existing web pages, websites, browsers, applications, platforms, using widgets, plugins that are browser and platform agnostic. The present disclosure significantly improves the buying process of the one more product on e-commerce by leveraging tools of an internet and a metaverse environment to engage, inform and build enough conviction on choices buyers are making as products/brands. The present disclosure provides a method and system for check-out of purchases within a browser or a metaverse environment that can be conveniently and seamlessly experienced at different points in time by the buyer. The flexibility to load one or more products into a meta-cart enables the buyer to increase confidence on the product opted for buying, upon associating the product simulations and validation in the metaverse environment.

The present disclosure provides a method and system for providing the buyer with a Non-Fungible Token (NFT) instance of the purchase transaction so that transaction and the transaction ownership is block-chain imprinted assuring of the needed hygiene to further transact within the metaverse environment. The present disclosure provides a method and system for optimizing the NFT generation costs by providing mint NFT technique in the overall meta-cart check-out process keeping a digital wallet value optimization in focus. The present disclosure provides a method and system for conjoint process of purchase/toggle between both the web and the metaverse environments in ecommerce. The present disclosure provides comfort and conviction of a fully validated purchase transaction. The present disclosure provides ownership to the user, as basis for any digital instance of a product and enabling blockchain validation of such ownerships through Non-Fungible Tokens (NFTs) to avoid confusion and fraudulent resale of a pre-owned product. The present disclosure provides meta-cart checkout purchase/buying process flow that integrates the web and Metaverse environments from the standpoint of immersive commerce that gives the user both the convenience and conviction to buy after getting a comprehensive and real sense of the products in terms of its size, scale, fit, detail & configuration/customization options. the meta-cart checkout process is aimed at stacking the shopping cart provisionally (or it can also be treated as the penultimate shopping cart, not the final check-out ready cart) with items that are both meta-verse experience-able and otherwise.

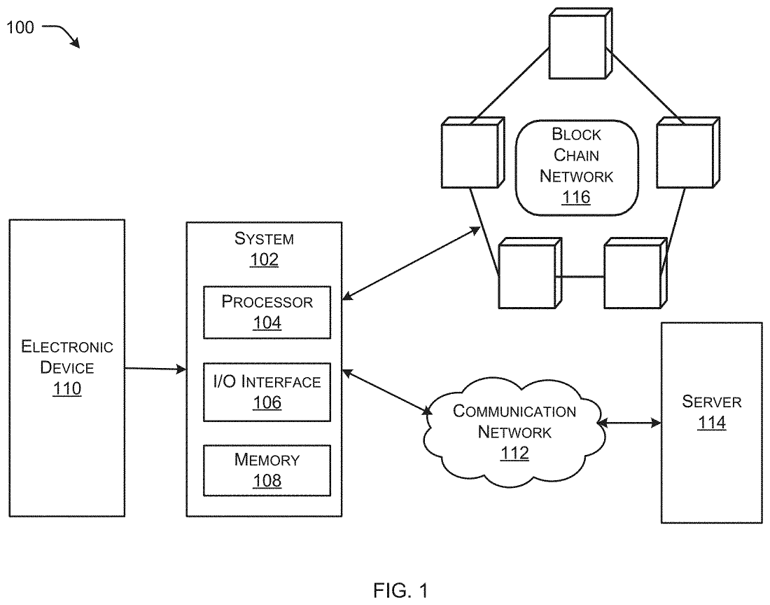

FIG. 1 illustrates an exemplary block diagram representation of a network architecture 100 implementing a proposed system 102 for undertaking a transaction in a Three-Dimensional (3D) interactive environment, according to embodiments of the present disclosure. The network architecture 100 may include the system 102, an electronic device 110, and a server 114. The system 102 may be connected to the server 114 via a communication network 112. The server 114 may include, but are not limited to, a stand-alone server, a remote server, cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 112 may be a wired communication network or a wireless communication network. The wireless communication network may be any wireless communication network capable to transfer data between entities of that network such as, but are not limited to, a carrier network including circuit switched network, a public switched network, a Content Delivery Network (CDN) network, a Long-Term Evolution (LTE) network, a Global System for Mobile Communications (GSM) network and a Universal Mobile Telecommunications System (UMTS) network, an Internet, intranets, local area networks, wide area networks, mobile communication networks, combinations thereof, and the like.

The system 102 may be implemented by way of a single device or a combination of multiple devices that may be operatively connected or networked together. For instance, the system 102 may be implemented by way of standalone device such as the server 114, and the like, and may be communicatively coupled to the electronic device 110. In another instance, the system 102 may be implemented in the electronic device 110. The electronic device 110 may be any electrical, electronic, electromechanical and computing device. The electronic device 110 may include, but are not limited to, a mobile device, a smart phone, a Personal Digital Assistant (PDA), a tablet computer, a phablet computer, a wearable device, a Virtual Reality/Augment Reality (VR/AR) device, a laptop, a desktop, and the like. The system 102 may be implemented in hardware or a suitable combination of hardware and software. Further, the system 102 may include a processor 104, an Input/Output (I/O) interface 106, and a memory 108. The Input/Output (I/O) interface 106 on the system 102 may be used to receive input from a user to undertake experiential experiments on a plurality of products that form part of an invoked metaverse environment, or to select one or more products based on the experiential experiments, and placing the selected one or more products into a cart along with transmitting Three-Dimensional (3D) metadata associated with the one or more products to the server 114. The metaverse environment may be referred to as virtual universes or worlds, are computer-based simulated environments intended for users to inhabit, traverse, and interact via avatars, which are personas or representations of the users of the metaverse, and generally take the form of two-dimensional or three-dimensional human or fantastical representations of a person's self. The metaverse according to the present disclosure may provide, but are not limited to, immersive e-commerce/merchandising entail spatial/virtual representations of one or more products across different customer touch-points of the products/product ads, search results, web pages, browsers, platforms/applications, and the like. The metaverse creates user-driven, fully immersive digital experiences that connect with the physical offering of the one or more products. The metaverse e-commerce may provide physical and digital worlds the ease of exchanging efficiently and experiencing consistently product details for a well-informed purchase decision.

Further, the system 102 may also include other units such as a display unit, an input unit, an output unit and the like, however the same are not shown in the FIG. 1, for the purpose of clarity. Also, in FIG. 1 only few units are shown, however the system 102 may include multiple such units or the system 102 may include any such numbers of the units, obvious to a person skilled in the art or as required to implement the features of the present disclosure. The system 102 may be a hardware device including the processor 104 executing machine-readable program instructions to undertake a transaction in the Three-Dimensional (3D) interactive environment. Execution of the machine-readable program instructions by the processor 104 may enable the proposed system 102 to undertake the transaction in 3D interactive environment. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor 104 may include, for example, but are not limited to, microprocessors, microcomputers, microcontrollers, digital signal processors, central processing units, state machines, logic circuits, any devices that manipulate data or signals based on operational instructions, and the like. Among other capabilities, the processor 104 may fetch and execute computer-readable instructions in the memory 108 operationally coupled with the system 102 for performing tasks such as data processing, input/output processing, feature extraction, and/or any other functions. Any reference to a task in the present disclosure may refer to an operation being or that may be performed on data.

In the example that follows, assume that a user of the system 102 desires to improve/add additional features undertaking a transaction in the Three-Dimensional (3D) interactive environment. In this instance, the user may include an administrator of a website, an administrator of an e-commerce site, an administrator of a social media site, an administrator of a social media application, an administrator of media content (e.g., television content, video on demand content, online video content, graphical content, image content, augmented/virtual reality content, meta verse content), among other examples, and the like. The system 102 when associated with the electronic device 110 or the server 114 may include a touch panel, a soft keypad, a hard keypad (including buttons) and the like. For example, the user may click a soft button on a touch panel of the electronic device 110 or the server 114 to confirm a shopping request to purchase, for example, a mobile device. In a preferred embodiment, the system 102 via the electronic device 110 or the server 114 may be configured to receive a request from the user via a graphical user interface on the touch panel. As used herein, the graphical user interface may be a user interface that allows a user of the system 102 to interact with the system 102 through graphical icons and visual indicators, such as secondary notation, and any combination thereof, and may comprise of a touch panel configured to receive an input using a touch screen interface.

The system 102 may be logically connected directly or indirectly via networking means to a blockchain network 116. While a single blockchain network is shown in FIG. 1, it is understood that multiple blockchain networks may be utilized to conduct transactions of the underlying blockchain and cryptocurrency capabilities described herein. As illustrated in FIG. 1, the blockchain network 116 may be an illustrative example in accordance with at least one embodiment of the present disclosure. The blockchain network 116 illustrates a simplified blockchain having blocks. The blocks may include a genesis block. Each block may include certain information, such as an identification, or hash, that uniquely identifies the block, a timeline identifying previous blocks (e.g., the hash numbers of previous blocks) in chronological order, transactions to record all transfers between a sender and a receiver, and a public key that identifies at least one sender and at least one receiver. The linked blocks therefore form a chain where each link, or block, in the chain uniquely identifies a previous link, or block, by including the hash or the prior link, or block. The blockchain network 116, may be a distributed ledger, or blockchain may be distributed, or replicated, on a network. The distributed ledger may be replicated and maintained on a database within the underlying blockchain network 116. Further, a distributed secure transaction ledger, in the form of the blockchain network 116, may be used to communicate data. The blockchain network 116 (or decentralized secure transaction ledger) may be one that is maintained by nodes in a distributed network. Although each block of blockchain network 116/ledger may include differentiated information and may have distinct purposes, each block may include a sample communication or message. In addition, the blockchain network 116 may include a Non-Fungible Token (NFT), which may be a unique and non-interchangeable unit of data stored on a digital ledger. The NFTs can be associated with easily-reproducible items such as, but are not limited to, photos, videos, audio, and other types of digital files as unique items, and use blockchain technology of the blockchain network 116 to provide the NFT a public proof of ownership.

In an embodiment, the system 102 may invoke, from a source application (not shown in FIG. 1), using a widget (not shown in FIG. 1), a metaverse environment (not shown in FIG. 1) from a plurality of available metaverse environments (not shown in FIG. 1), the invocation of the metaverse environment enabling a user to undertake experiential experiments on a plurality of products that form part of the invoked metaverse environment. The source application may be selected from, but are not limited to, a web page, a web application, a desktop application, or a document, and the like. The widget may be embedded and persistent in, but are not limited to, a web page, a web browser, an application, a platform, and the like. The plurality of products may be represented as virtual objects in the invoked metaverse environment. The plurality of products may include, but are not limited to, apparels, electronic devices, spare parts, components, electronic parts, mechanical parts, groceries, items, wood items, home décor items, home appliances, home essentials, and the like. In an embodiment, the invoked metaverse environment may have one or more specifications selected from, but are not limited to, the environment attributes, controls, parameters, and the like, that enable the cart to be optimized for intended user experience that is compatible with the user space, the specifications ranging from Two/Three-Dimensional to virtual/augmented reality environments. With the specifications, user intent may be mapped to determine desired product features in the metaverse environment to visualize before purchase. Upon identification of the personalized user intent, control(s) to edit product information in the desired user intent are presented to the user along with optimizing the metaverse environment for completion of the user intent, the control(s) being selected from any or a combination of gesture-based controls, device-based controls, voice-based controls, or retail tracking to execute the transaction.

Further, the system 102 may select one or more products based on the experiential experiments. Furthermore, the system 102 may process, in the invoked metaverse environment, using a meta-cart checkout engine (not shown in FIG. 1) of the invoked metaverse environment, purchase transaction for the selected one or more products. In an embodiment, the meta-cart checkout engine may place the selected one or more products into a cart (such as meta-cart) along with transmitting 3D metadata associated with the one or more products to the server 114. The 3D metadata includes, but are not limited to, product information associated with the one or more products, product attributes, personalization information, experimentation and utility-based information, product intent oriented data, and the like. The 3D metadata may be stored on a centralized or a decentralized server medium (not shown in FIG. 1) that may be triggered by a client application architecture.

In an embodiment, the system 102 may further perform, using a minting engine (now shown in FIG. 1), Just-In-Time (JIT) minting of one or more meta-physical Non-Fungible Tokens (NFTs) for the purchase transaction. The NFTs may be representative of, but are not limited to, the selected one or more products, the purchase transaction, the 3D metadata, a part thereof, and the like. In an embodiment, the NFT may be minted on the blockchain network 116 to enable the NFT unchangeable and tamper proof and enable validation of ownership of the selected one or more products. In case, the user decides to cancel or revoke the purchase transaction, the NFT may be automatically burnt and the selected one or more products are initiated with a return-workflow.

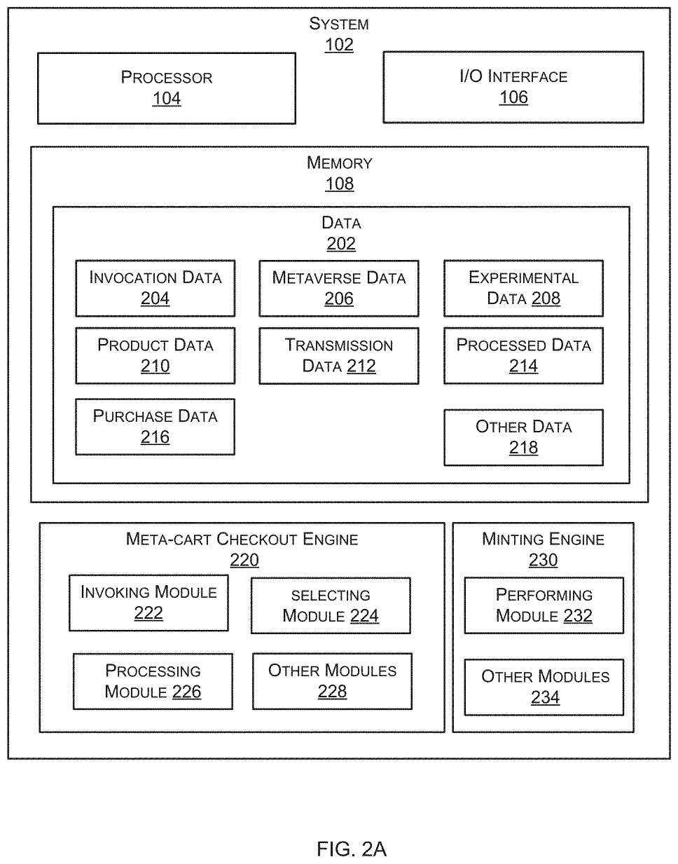

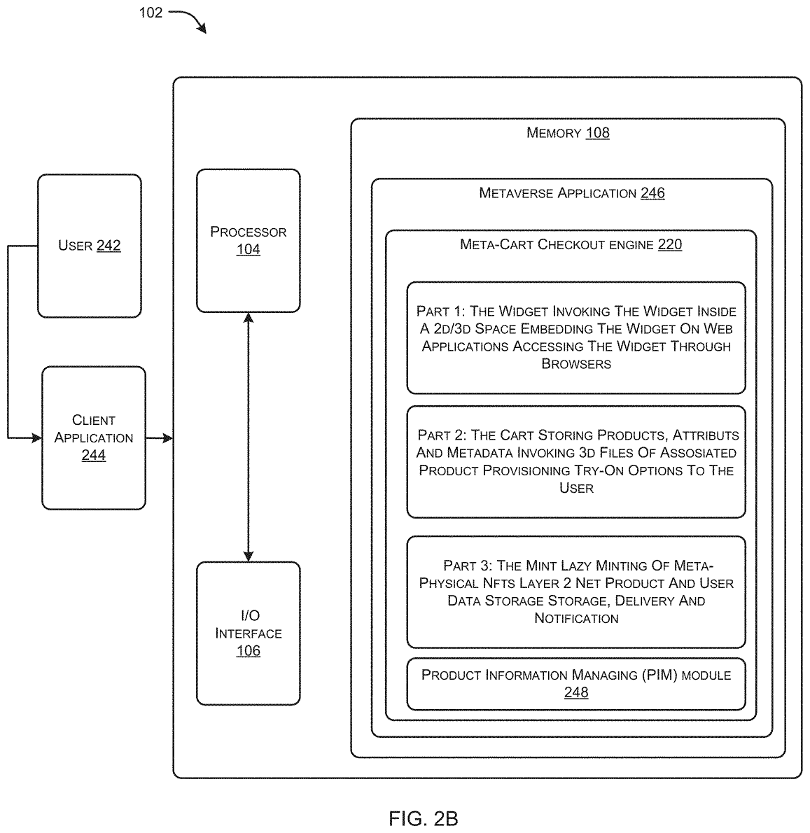

FIG. 2A illustrates a detailed block diagram representation of the proposed system 102, according to embodiments of the present disclosure. The system 102 may include the processor 104, the Input/Output (I/O) interface 106, and the memory 108. In some implementations, the system 102 may include data 202, a meta-cart checkout engine 220, and a minting engine 230. As an example, the data 202 is stored in the memory 108 configured in the system 102 as shown in the FIG. 2A. In an embodiment, the data 202 may include invocation data 204, metaverse data 206, experimental data 208, product data 210, transmission data 212, processed data 214, purchase data 216, and other data 218. In an embodiment, the data 202 may be stored in the memory 108 in the form of various data structures. Additionally, the data 202 can be organized using data models, such as relational or hierarchical data models. The other data 218 may store data, including temporary data and temporary files, generated by the meta-cart checkout engine 220, and the minting engine 230 for performing the various functions of the system 102.

In an embodiment, the meta-cart checkout engine 220, may include an invoking module 222, a selecting module 224, a processing module 226, and other modules 228. In an embodiment, the minting engine 230 may include a performing module 232, and other modules 234.

In an embodiment, the data 202 stored in the memory 108 may be processed by the meta-cart checkout engine 220, and the minting engine 230 of the system 102. The meta-cart checkout engine 220, and the minting engine 230 may be stored within the memory 108. In an example, the meta-cart checkout engine 220, and the minting engine 230 communicatively coupled to the processor 104 configured in the system 102, may also be present outside the memory 108, as shown in FIG. 2A, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

In an embodiment, the invoking module 222 may invoke, from a source application (not shown in FIG. 2A), using a widget (not shown in FIG. 2A), a metaverse environment (not shown in FIG. 2A), from a plurality of available metaverse environments, the invocation of the metaverse environment enabling a user to undertake experiential experiments on a plurality of products that form part of the invoked metaverse environment. The data related to the invoked metaverse environment may be stored as the invocation data 204. The data related to the metaverse environment from the plurality of available metaverse environments may be stored as the metaverse data 206. The undertook experiential experiments may be stored as the experimental data 208. The one or more products may be stored as the product data 210. The source application may be selected from any or a combination of, but are not limited to, a web page, a web application, a desktop application, a document, and the like. The widget may be embedded and persistent in a web browser or an application/platform. The plurality of products that are represented as virtual objects in the invoked metaverse environment.

In an embodiment, the invoked metaverse environment may have one or more specifications selected from one or more metaverse environment attributes, controls, and parameters that enable the cart to be optimized for intended user experience that may be compatible with the user of the electronic device 110, the specifications ranging from Two/Three-Dimensional (2D/3D) to virtual/augmented reality environments. With the specifications, a user intent may be mapped to determine desired product features in the metaverse environment to visualize by the user before purchase. Upon identification of the personalized user intent, control(s) to edit product information in the desired user intent may be presented to the user, by the system 102, along with optimizing the metaverse environment for completion of the user intent, the control(s) being selected from any or a combination of gesture-based controls, device-based controls, voice-based controls, or retail tracking to execute the transaction. For instance, the invoking module 222 may invoke metaverse environment from existing web pages using widgets, plugins that are browser and platform agnostic. The widget can be used as the tool to invoke the metaverse environment from an existing web page. Further, a metaverse application (not shown in FIG. 2A) may allow the user to add commerce specific products or a plurality of products to the metaverse environment with/without being logged in or active in the metaverse environment at the time the product is added via the invoking module 222.

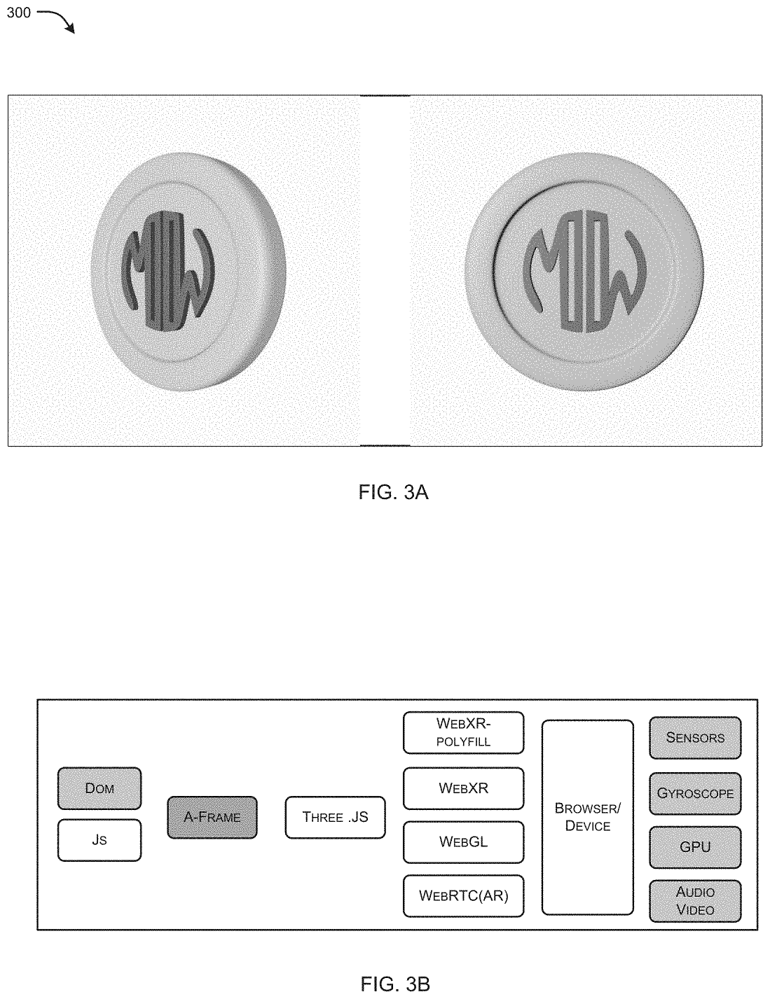

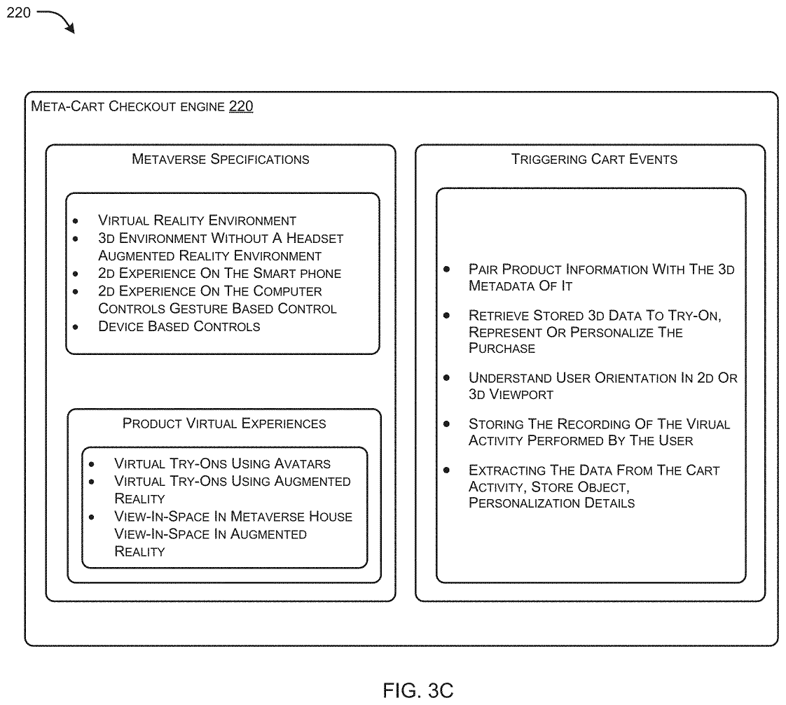

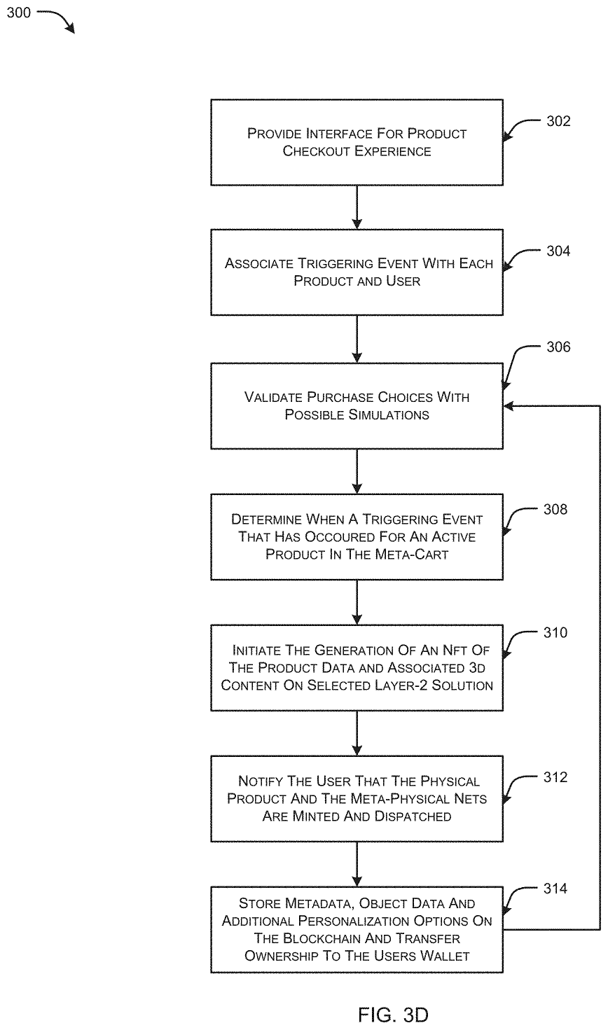

The user such as the user 242 may be allowed to enable a three-step/parts function such as invoking, checkout, and minting as shown in FIG. 2B. In part 1, FIG. 2B depicts invoking the widget. Due to existence of a shared persistent space between Two Dimension (2D) and Three-Dimension (3D) environment in the web pages, browser, application/platform associated with the electronic device 110, it may be a necessity to have a persistent workflow or methodology to invoke the functionality of a commerce specific series of steps by the user 242. The widget such as, for example, a widget 300 shown in FIG. 3A may be a tool or simple browser extension to invoke the metaverse environment from the browser. The widget 300 may have a look and feel of a coin and look like an icon presented in terms of a typical depiction shown in FIG. 3A. The widget 300 may be a component that can be embedded into and, may be invoked from, but are not limited to, a browser, a mobile display, a laptop/desktop display, content pages of one or more websites be it the landing website/web page or specific other interaction web pages the user 242 navigates through. Using an embedding technique, the widget 300 may be embedded within, but are not limited to, a browser, web page, application, platform, and the like. The widget 300 may be based on an open interoperable technical composition that can be embedded everywhere in the electronic device 110, easily inside of both the web and metaverse environments as shown in FIG. 3B. The widget 300 can also be called as a browser extension and the widget 300 may add convenience to metaverse browsing experience to the user 242 with ease to navigate metaverse resources.

The widget 300 may provide hooks which may be necessary to create an open interoperable metaverse environment. The widget 300 may essentially be a gateway to lead the user 242 into virtual worlds that may be similar to the web-internet of today, but with virtual places instead of web pages. In an instance, the widget 300 may be embedded using one or more JavaScript (JS) frameworks as shown in FIG. 3B, which may be interoperability built-in and agnostic to the electronic devices 110, browsers and platforms in the electronic device 110. For example, the widget 300 may be an embeddable component across all user touchpoints and also across, but are not limited to, the desktop, mobile devices, consoles, Virtual Reality (VR) headset screens (even as the form factor transitions from the clunky to elegant end in the ease-of-use perspectives). The widget 300 may be developed using a A-Frame shown in FIG. 3B, that enables the widget 300 interoperable widget with one or more Web-XR shown in FIG. 3B, supported web/metaverse supported device such as the electronic device 110.

In an embodiment, the selecting module 224 may select one or more products based on the experiential experiments. Further, the processing module 226 may process, in the invoked metaverse environment, using a meta-cart checkout engine 220 of the invoked metaverse environment, purchase transaction for the selected one or more products. The meta-cart checkout engine 220 may place the selected one or more products into a cart along with transmitting 3D metadata associated with the one or more products to the server 114. The transmitted 3D metadata may be stored as the transmission data 212. The processed purchase transaction may be stored as the processed data 214. The purchased one or more products may be stored as the purchase data 216. The 3D metadata includes any or a combination of product information associated with the one or more products, product attributes, personalization information, experimentation and utility-based information, and product intent oriented data, the 3D metadata being stored on a centralized or a decentralized server medium that is triggered by a client application architecture 244 shown in FIG. 2B.

For instance, a part 2 shown in FIG. 2B may include a meta-cart checkout process using the meta cart checkout engine 220 via the processing module 226. The detailed steps of the meta cart checkout engine 220 is shown in FIG. 3C. The fundamental objective of the meta-cart checkout process may be to reinforce buying conviction into the end user 242 with regards to both purpose fit and associated value of the metaverse experienceable products. A conviction building may be a function of product attributes and a product attributes context of use that can be simulated in the relevant ways inside virtual world such as the metaverse environment evoked by the widget 300. The meta-cart checkout process may provide seamless toggle between the digital and physical environment for the user 242 (i.e., buyer) in enabling the experiential dimension of buying. Depending upon the readiness of the user 242 with the required virtual environment such as the metaverse environment related electronic accessory devices/wearable devices, the user 242 can at any point in time perform the experiential experiment on the one or more products on e-commerce site. The ability to utilize additional product information, personalization, experimentation and utility may be enabled through the existence of the meta-cart checkout process. For instance, meta-cart checkout may be a process flow of purchasing/buying that integrates the web and metaverse environments from the standpoint of immersive e-commerce that gives the user 242 both the convenience and conviction to buy after realizing a comprehensive and real sense of the one or more products in terms of, but are not limited to, product size, scale, fit, detail, configuration/customization options, and the like. In an instance, the widget 300 may be essentially be persistent in a browser header and can enable different metaverses environments, virtual worlds across different web pages from an e-commerce website. The immersive e-commerce may be effective with a proper integration of widget 300, without slowing down a web page or web place from the internet or the metaverse environment.

With reference to FIG. 2B, the meta-cart checkout engine 220 may utilize information retrieved from a client application 244 and a metaverse application 246, one or more product intents and one or more triggering events. The product intent/product virtual experiences may include, but are not limited to, virtual try-ons using avatars, virtual try-ons using augmented reality, view-in-space in metaverse house, view-in-space in augmented reality, and the like. The triggering events may include, but are not limited to, pair product information with the associated 3d metadata, retrieve stored 3D data to try-on, represent or personalize the purchase, understand user 242 orientation in 2D or 3D viewport, storing the recording of the virtual activity performed by the user 242, extracting the data from the cart activity, store object, personalization details, and the like.

The client application 244 and a metaverse application 246 may have specifications such as, but are not limited to, an environment, controls and parameters that enable the cart to optimize for the experience that is compatible with the electronic device 110 or browser, or platform, and the like. Metaverse specifications can range from 2D or 3D environments and across virtual or augmented reality as shown in FIG. 3C. The metaverse specification may include, but are not limited to, virtual reality environment, 3D environment without a headset augmented reality environment, 2D experience on the smart phone, 2D experience on the computer controls gesture-based control, device-based controls, and the like. With the specifications, the user 242 intent may be mapped to understand the product features such as, but are not limited to, better personalizing characteristics, trialing features and placing the product in an environment to visualize before purchase, and the like. For instance, if an intent of the user 242 is identified, then the controls to edit the product data in the desired intent is presented to the user 242 with application specific environment parameters being optimized for the completion of the intent. This can include, but are not limited to, gesture-based controls, device-based controls, voice-based controls or retail tracking to execute on personalization, visualization or utility trialing functions of the object by the user 242, and the like. These events may be invoked by the user 242 through deliberate actions that are marked as triggered events as shown in FIG. 3C. The event triggers may be a combination of passive application specific work such as, but are not limited to, storing product data and 3D in a ready to use manner, to extracting data about personalization post a virtual experience session. Further, the meta-cart checkout engine 220 may store information about the user's actions such as, but are not limited to, invoking the cart, editing options of the product through the cart checkout and eventually to the product minting, and the like. The information may be stored on a centralized or a decentralized server medium that is triggered by the client application architecture 244.

For instance, the meta-cart checkout process may stack the shopping cart on e-commerce website provisionally (or meta-cart checkout process can also be treated as the penultimate shopping cart, not the final check-out ready cart) with items that are both meta-verse experience-able and otherwise. The movement of one or more meta-compatible products into a single basket (or cart) helps in getting a Product Information Managing (PIM) module 248 shown in FIG. 2B, primed with the associated 3D meta data of the one or more products. The purpose of the perpetual feature of meta-cart in immersive e-commerce is more to provide convenience to the user 242 (who may or may not be sufficiently geared up just at the instance of browsing the product arrays for options available) to enable the metaverse experiential trials and more humanized buying, at a later point in time, whenever the user 242 is ready with needed electronic accessory devices/wearable devices for the bringing-up the metaverse environment and also an avatar of the user 242.

In an embodiment, the performing module 232 may perform, using a minting engine 230, just-in-time minting of meta-physical Non-Fungible Token (NFT) for the purchase transaction, the NFT being representative of any or a combination of the selected one or more products, the purchase transaction, the 3D metadata, or a part thereof. The NFT may be minted on a blockchain to enable the NFT unchangeable and tamper proof and enable validation of ownership of the selected one or more products. In case the user 242 decides to cancel or revoke the purchase transaction, the NFT is automatically burnt and the selected one or more products are initiated with a return-workflow.

For instance, the meta-cart checkout process may further be strengthened with a metaverse centric or lazy or just-in time mint Non-Fungible Token (NFT) feature built-in the meta-cart checkout process. This may help in just-in-time minting of NFTs after the user 242 (i.e., buyer) has finalized set of one or more products as check-out items. The NFTs may be conserved and delivered upon the required efficiencies needed in managing a digital wallet associated with the user 242. The immersive commerce value chain may be completed only with capture of all data as part of the meta-cart-based checkout/purchase process. The NFTs may be a minted using, for example, an Ethereum blockchain network associated with the blockchain network 116. Upon minting the NFT Ethereum blockchain network associated with the blockchain network 116, the NFT may be unchangeable and tamper-proof. In an instance, the minting may be associated with a gas fee which are payments to be made in exchange for the computing energy for processing and validating transactions of Ethereum blockchain network associated with the blockchain network 116. Further, the NFTs may be usually bought either with a cryptocurrency or in dollars, and the blockchain network 116 may keep a record of transactions for buying NFT. In case, for example, when gas fees are high, minting NFTs can be costly when bought using an Ethereum cryptocurrency. This results in users needing to spend more money just to buy the NFTs. Sometimes one or more products may be sold by the user 242 and the user (i.e., seller) may lose money because of the gas fees to mint the NFTs. This proves to be a poor economic model to build scalable commerce functionality. Hence, to solve for the problem of providing meta-physical items the part 3 shown in FIG. 2B, of the meta-cart checkout process may include, but are not limited to, forging of digital goods, delivered in compatible file formats such as Graphics Language Transmission Format (GLTF) and associated physical counterparts as well, the meta-cart checkout process may use a metaphysical lazy minting process as shown in flow chart of FIG. 3D.

The lazy minting may be a process when an NFT is available ‘off-chain’ or off the blockchain network 116, and only be minted once there is a sale of the NFT. This implies that the user (i.e., creator or seller) does not have to pay any upfront gas fees to mint respective NFT. The gas fees may only be paid once the NFT is purchased and transferred ‘on-chain’ or on the block chain network 116. In another implementation, the lazy minting process may defer the payment of gas fees until the NFT is sold. Through the lazy minting process, the user (i.e., seller) may be able to effectively mint products on chain available for the metaverse environment on an as-needed basis. This proof of ownership also translates to the real-world product that would be shipped to the user 242 as applicable. Through the use of a layer-2 solution (i.e., metaphysical lazy minting process) and effective rollups, the process of metaphysical lazy minting enables product ownership across multiple defined realities. In an example, the user 242 of the electronic device 110 may choose to mint the NFTs by way of lazy minting process, since minting tokens can often be cost-prohibitive. Depending on the price of Ethereum cryptocurrency in the blockchain network 116 and how high gas fees are, lazy minting process may provide an alternative and way to wait out a period of high gas fees until the gas fees are lower. Further, minting at Just-In-Time (JIT) as part of the meta-cart checkout process using the prevailing rates in the blockchain network 116 is provided to optimize the spending of the user 242. In an instance, the minting of the NFT may also be prescribed as an optional step, in case the buyer wants to opt for or the seller has already prescribed a predetermined NFTs cost for the digital instance of the one or more product, if applicable, as part of the purchase of the one or more products. The lazy minting process may entail paying the gas fee, allowing the Ethereum cryptocurrency transactions to process on the blockchain network 116. Upon the completion of the transaction, the buyer may be able to see the minted NFT on a profile associated with the user 242, as a confirmation of the transaction completion. In the scenario that the buyer decides to cancel the said order, or revoke the purchase, the NFT is automatically burnt and the one or more products may be initiated with a return workflow as mandated by the seller. The immersive commerce may provide better prospects for user 242 to understand the meta-commerce merchandise while enabling the e-commerce (i.e., merchandiser) to better understand customer perception of that same e-commerce. This kind of quantifiable interactivity may not be possible without leveraging data related to meta-cart checkout process.

Referring to FIG. 3D, at step 302, the method 300 includes providing interface to the user 242 for the one or more products to checkout at e-commerce. At step 304, the method 300 includes associating one or more trigger events with each product and user 242. At step 306, the method 300 includes validate purchase choices with possible situations. At step 308, the method 300 includes determining, when a trigger event that has occurred for an active product in the meta-cart. At step 310, the method 300 includes initiating the generation of the NFT of the product data and associated 3D content on selected layer 2 solution. At step 312, the method 300 includes notifying the user 242 that the physical product and the meta-physical nets are minted and dispatched. At step 314, the method 300 includes storing metadata, object data and additional personalization options of the user 242 on the blockchain network 116 and transferring ownership to the digital wallet of the user 242.

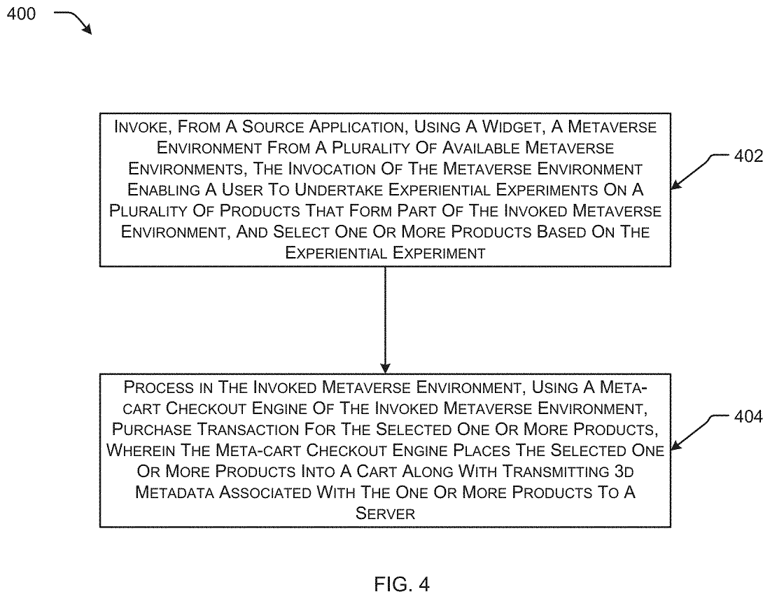

FIG. 4 illustrates a flow diagram depicting method 400 of undertaking a transaction in the Three-Dimensional (3D) interactive environment, according to embodiments of the present disclosure.

At block 402, the method 400 includes, invoking, by the processor 104 associated with the system 102, from a source application 244, using the widget 300, a metaverse environment from a plurality of available metaverse environments, the invocation of the metaverse environment enabling the user 242 to undertake experiential experiments on a plurality of products that form part of the invoked metaverse environment, and the method 400 includes selecting one or more products based on the experiential experiments. At block 404, the method 400 includes processing, by the processor 104, in the invoked metaverse environment, using a meta-cart checkout engine 220 of the invoked metaverse environment, purchase transaction for the selected one or more products. The meta-cart checkout engine 220 places the selected one or more products into a cart along with transmitting 3D metadata associated with the one or more products to the server 114.

The order in which the method 400 are described is not intended to be construed as a limitation, and any number of the described method blocks may be combined or otherwise performed in any order to implement the method 400 or an alternate method. Additionally, individual blocks may be deleted from the method 500B without departing from the spirit and scope of the present disclosure described herein. Furthermore, the method 400 may be implemented in any suitable hardware, software, firmware, or a combination thereof, that exists in the related art or that is later developed. The method 400 describe, without limitation, the implementation of the system 102. A person of skill in the art will understand that method 400 may be modified appropriately for implementation in various manners without departing from the scope and spirit of the disclosure.

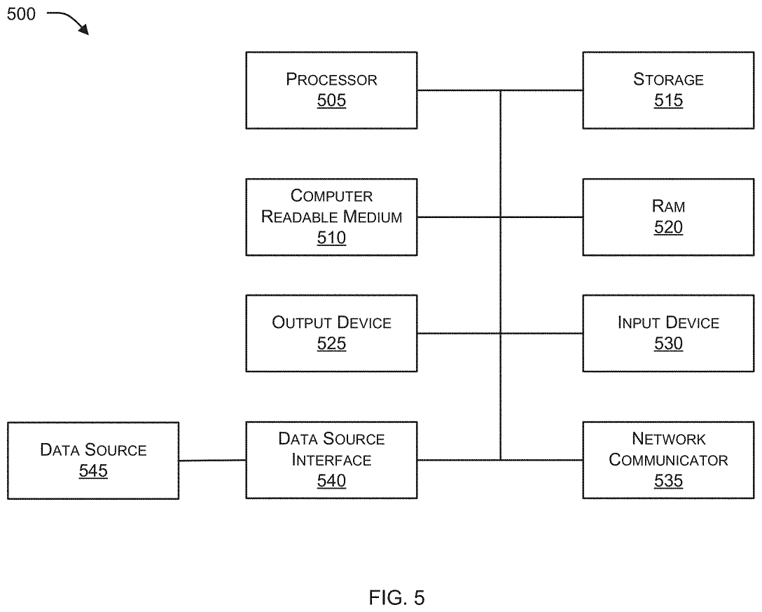

FIG. 5 illustrates a hardware platform 500 for implementation of the disclosed system 102, according to an example embodiment of the present disclosure. For the sake of brevity, construction and operational features of the system 102 which are explained in detail above are not explained in detail herein. Particularly, computing machines such as but not limited to internal/external server clusters, quantum computers, desktops, laptops, smartphones, tablets, and wearables which may be used to execute the system 102 or may include the structure of the hardware platform 500. As illustrated, the hardware platform 500 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 500 may be a computer system such as the system 102 that may be used with the embodiments described herein. The computer system may represent a computational platform that includes components that may be in a server or another computer system. The computer system may execute, by the processor 505 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and documents and analyze documents. In an example, the meta-cart checkout engine 220, and the minting engine 230, may be software codes or components performing these steps.

The instructions on the computer-readable storage medium 510 are read and stored the instructions in storage 515 or in random access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interact with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for instance. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a method and system for undertaking a transaction in a Three-Dimensional (3D) interactive environment.

The present disclosure provides a method and system for invoking, utilizing and minting one or more products using a metaverse cart checkout process in a metaverse environment. The metaverse environment may be invoked from existing web pages, websites, browsers, applications, platforms, using widgets, plugins that are browser and platform agnostic.

The present disclosure significantly improves the buying process of the one more product on e-commerce by leveraging tools of an internet and a metaverse environment to engage, inform and build enough conviction on choices buyers are making as products/brands.

The present disclosure provides a method and system for check-out of purchases within a browser or a metaverse environment that can be conveniently and seamlessly experienced at different points in time by the buyer. The flexibility to load one or more products into a meta-cart enables the buyer to increase confidence on the product opted for buying, upon associating the product simulations and validation in the metaverse environment.

The present disclosure provides a method and system for providing the buyer with a Non-Fungible Token (NFT) instance of the purchase transaction so that transaction and the transaction ownership is block-chain imprinted assuring of the needed hygiene to further transact within the metaverse environment.

The present disclosure provides a method and system for optimizing the NFT generation costs by providing mint NFT technique in the overall meta-cart check-out process keeping a digital wallet value optimization in focus.

The present disclosure provides a method and system for conjoint process of purchase/toggle between both the web and the metaverse environments in ecommerce.

The present disclosure provides comfort and conviction of a fully validated purchase transaction.

The present disclosure provides ownership to the user, as basis for any digital instance of a product and enabling blockchain validation of such ownerships through Non-Fungible Tokens (NFTs) to avoid confusion and fraudulent resale of a pre-owned product.

The present disclosure provides meta-cart checkout purchase/buying process flow that integrates the web and Metaverse environments from the standpoint of immersive commerce that gives the user both the convenience and conviction to buy after getting a comprehensive and real sense of the products in terms of its size, scale, fit, detail & configuration/customization options. the meta-cart checkout process is aimed at stacking the shopping cart provisionally (or it can also be treated as the penultimate shopping cart, not the final check-out ready cart) with items that are both meta-verse experience-able and otherwise.

We claim:

1. A method for undertaking a transaction in a Three-Dimensional (3D) interactive environment, comprising:
invoking, by a processor associated with a system, from a source application, using a widget, a metaverse environment from a plurality of available metaverse environments, the invocation of the metaverse environment enabling a user to undertake experiential experiments on a plurality of products that form part of the invoked metaverse environment, and selecting one or more products based on the experiential experiments; and
processing, by the processor, in the invoked metaverse environment, using a meta-cart checkout engine of the invoked metaverse environment, purchase transaction for the selected one or more products, wherein the meta-cart checkout engine places the selected one or more products into a cart along with transmitting 3D metadata associated with the one or more products to a server.

2. The method as claimed in claim 1, further comprising:
performing, by the processor, using a minting engine, just-in-time minting of meta-physical non-fungible token (NFT) for the purchase transaction, the NFT being representative of any or a combination of the selected one or more products, the purchase transaction, the 3D metadata, or a part thereof.

3. The method as claimed in claim 2, wherein the NFT is minted on a blockchain to enable the NFT unchangeable and tamper proof and enable validation of ownership of the selected one or more products.

4. The method as claimed in claim 2, wherein, in case the user decides to cancel or revoke the purchase transaction, the NFT is automatically burnt and the selected one or more products are initiated with a return-workflow.

5. The method as claimed in claim 1, wherein the source application is selected from any or a combination of a web page, a web application, a desktop application, or a document.

6. The method as claimed in claim 1, wherein the widget is embedded and persistent in a web browser or an application/platform.

7. The method as claimed in claim 1, wherein the plurality of products that are represented as virtual objects in the invoked metaverse environment.

8. The method as claimed in claim 1, wherein the 3D metadata comprises any or a combination of product information associated with the one or more products, product attributes, personalization information, experimentation and utility-based information, and product intent oriented data, the 3D metadata being stored on a centralized or a decentralized server medium that is triggered by a client application architecture.

9. The method as claimed in claim 1, wherein the invoked metaverse environment has one or more specifications selected from the environment attributes, controls, and parameters that enable the cart to be optimized for intended user experience that is compatible with the user space, the specifications ranging from Two/Three-Dimensional to virtual/augmented reality environments, wherein with the specifications, user intent is mapped to determine desired product features in the metaverse environment to visualize before purchase.

10. The method as claimed in claim 1, wherein, upon identification of the personalized user intent, control(s) to edit product information in the desired user intent are presented to the user along with optimizing the metaverse environment for completion of the user intent, the control(s) being selected from any or a combination of gesture-based controls, device-based controls, voice-based controls, or retail tracking to execute the transaction.

11. A system for undertaking a transaction in a Three-Dimensional (3D) interactive environment, the system comprising:
a processor;
a memory storing a set of instructions, which when executed by the processor, cause the processor to:
invoke, from a source application, using a widget, a metaverse environment from a plurality of available metaverse environments, the invocation of the metaverse environment enabling a user to undertake experiential experiments on a plurality of products that form part of the invoked metaverse environment, and select one or more products based on the experiential experiments; and
process, in the invoked metaverse environment, using a meta-cart checkout engine of the invoked metaverse environment, purchase transaction for the selected one or more products, wherein the meta-cart checkout engine places the selected one or more products into a cart along with transmitting 3D metadata associated with the one or more products to a server.

12. The system as claimed in claim 11, wherein the system further causes the processor to:
perform, using a minting engine, just-in-time minting of meta-physical non-fungible token (NFT) for the purchase transaction, the NFT being representative of any or a combination of the selected one or more products, the purchase transaction, the 3D metadata, or a part thereof.

13. The system as claimed in claim 12, wherein the NFT is minted on a blockchain to enable the NFT unchangeable and tamper proof and enable validation of ownership of the selected one or more products.

14. The system as claimed in claim 12, wherein, in case the user decides to cancel or revoke the purchase transaction, the NFT is automatically burnt and the selected one or more products are initiated with a return-workflow.

15. The system as claimed in claim 11, wherein the source application is selected from any or a combination of a web page, a web application, a desktop application, or a document.

16. The system as claimed in claim 11, wherein the widget is embedded and persistent in a web browser or an application/platform.

17. The system as claimed in claim 11, wherein the plurality of products that are represented as virtual objects in the invoked metaverse environment.

18. The system as claimed in claim 11, wherein the 3D metadata comprises any or a combination of product information associated with the one or more products, product attributes, personalization information, experimentation and utility-based information, and product intent oriented data, the 3D metadata being stored on a centralized or a decentralized server medium that is triggered by a client application architecture.

19. The system as claimed in claim 11, wherein the invoked metaverse environment has one or more specifications selected from the environment attributes, controls, and parameters that enable the cart to be optimized for intended user experience that is compatible with the user space, the specifications ranging from Two/Three-Dimensional to virtual/augmented reality environments, wherein with the specifications, user intent is mapped to determine desired product features in the metaverse environment to visualize before purchase.

20. The system as claimed in claim 11, wherein, upon identification of the personalized user intent, control(s) to edit product information in the desired user intent are presented to the user along with optimizing the metaverse environment for completion of the user intent, the control(s) being selected from any or a combination of gesture-based controls, device-based controls, voice-based controls, or retail tracking to execute the transaction.
